(19) United States
(12) Patent Application Publication
(10) Pub. No.: US 2026/0097632 A1
(43) Pub. Date: Apr. 9, 2026

(54) VEHICLE AIR CONDITIONING SYSTEM

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/238,735

(22) Filed: Jun. 16, 2025

(30) Foreign Application Priority Data
Oct. 7, 2024 (JP) 2024-176020

(51) Int. Cl. B60H 3/02; B01D 53/26

(52) U.S. Cl. CPC B60H 3/02; B01D 53/261

(57) ABSTRACT

A vehicle air conditioning system 1 includes: a humidity controlling device 2 having an adsorption portion 20 and a heating means 21; a duct 3 including the humidity controlling device 2 therein and allowing air from a vehicle interior or a vehicle exterior to flow therethrough, the duct 3 having a vehicle interior flow path 30 for introducing air 10 that has passed through the humidity controlling device 2 into the vehicle interior, and a vehicle exterior flow path 31 for discharging the air 10 that has passed through the humidity controlling device 2 to the vehicle exterior, wherein a wall 4 is erected from an inner bottom surface 33 of the duct 3 between the humidity controlling device 2 and the vehicle interior flow path 30.

### FIELD OF THE INVENTION

The present invention relates to a vehicle air conditioning system.

### BACKGROUND OF THE INVENTION

In various types of vehicles such as automobiles, there are increasing requirements for improvement of vehicle interior environment. Specific requirements illustrate reduction of an amount of carbon dioxide in the vehicle interior to suppress driver's drowsiness, control of humidity in the vehicle interior, and removal of harmful volatile components such as odor components and allergy-causing components in the vehicle interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

Therefore, Patent Literature 1 proposes a vehicle air conditioning (air purifying) system including: a first flow path and a second flow path that are in communication with a vehicle interior; and an adsorption block located in each flow path. The adsorption block uses an adsorption material (zeolite) that can adsorb carbon dioxide and water vapor contained in air as adsorption target substances (purification target substances) and desorb the adsorption target substances when heated air passes through it. The first flow path and the second flow path branch downstream of the adsorption block into a flow path that is in communication with the vehicle interior and a flow path that is in communication with the outside of the vehicle interior, and a valve (switching mechanism) is provided in one of these flow paths to switch the flow of the air. According to the vehicle air conditioning system, it is possible to achieve simultaneously an operation in which one adsorption block adsorbs the adsorbent target substances and returns the purified air to the vehicle interior, and an operation in which the other adsorption block can exhaust the air that has desorbed the adsorption target substances to the outside of the vehicle interior, and also prevent unpurified air from flowing into the vehicle interior.

### CITATION LIST

### Patent Literatures

[Patent Literature 1] Japanese Patent Application Publication No. 2020-104774 A

### SUMMARY OF THE INVENTION

The adsorbent (adsorption material) capable of adsorbing and desorbing the adsorbent target substances described in Patent Literature 1 can adsorb moisture at a temperature lower than or equal to a predetermined temperature and desorb the moisture when the temperature exceeds the predetermined temperature.

However, the desorbed moisture can cause condensed water to be generated in the duct, and depending on the arrangement of the vehicle interior flow path that allows air to flow into the vehicle interior, the condensed water may be carried into the vehicle interior to increase the humidity in the vehicle interior.

This invention has been made to solve the problems described above, and one of objects thereof is to provide a vehicle air conditioning system that can reduce the risk of condensed water being carried into the vehicle interior to increase the humidity in the vehicle interior.
<1> In an embodiment, this invention relates to a vehicle air conditioning system, comprising: a humidity controlling device having an adsorption portion containing an adsorbent configured to adsorb moisture at a temperature lower than or equal to a predetermined temperature and to desorb the moisture when the temperature exceeds the predetermined temperature, and a heating means configured to heat the adsorption portion; a duct comprising the humidity controlling device therein and allowing air from a vehicle interior or a vehicle exterior to flow therethrough, the duct having a vehicle interior flow path for introducing the air that has passed through the humidity controlling device into the vehicle interior, and a vehicle exterior flow path for discharging the air that has passed through the humidity controlling device to the vehicle exterior,
   wherein the vehicle air conditioning system is formed by satisfying at least one of (1) and (2) as follows:
   (1) a wall is erected from an inner bottom surface of the duct between the humidity controlling device and the vehicle interior flow path or in the vehicle interior flow path, or an inlet of the vehicle interior flow path is provided at a position higher than the inner bottom surface of the duct; and
   (2) at least one drain hole is provided at the inner bottom surface of the duct between the humidity controlling device and the vehicle interior flow path or in the vehicle interior flow path.
<2> This invention may relate to the vehicle air conditioning system according to <1>, wherein the adsorption portion comprises: a structure having an outer wall and partition walls provided on an inner side of the outer wall, the partition walls defining flow paths for the air, each of the flow paths extending from a first end face to a second end face of the structure; and an adsorbing layer containing the adsorbent provided on a surface of each of the partition walls.
<3> The invention may relate to the vehicle air conditioning system according to <2>, wherein the heating means has a pair of electrodes connected to the structure, and the structure is heated by applying an electric current through the pair of electrodes.
<4> This invention may relate to the vehicle air conditioning system according to <3>, wherein at least the partition walls of the structure are made of a material having a PTC property.
<5> This invention may relate to the vehicle air conditioning system according to <2>, wherein the heating means has a pipe provided inside the structure, and the structure is heated by a heated medium flowing through the pipe.
<6> This invention may relate to the vehicle air conditioning system according to <2>, wherein the heating means has a heater for feeding heated air to the structure, and the structure is heated by allowing the heated air to flow through the structure.
<7> This invention may relate to the vehicle air conditioning system according to any one of <1> to <6>, wherein the vehicle interior flow path is provided below or to a side of the vehicle exterior flow path.
<8> This invention may relate to a vehicle air conditioning system according to any one of <1> to <7>, wherein a wall is erected from an inner bottom surface of the duct, and when a lower end of an inlet of the vehicle interior flow path is located at a position of the inner bottom surface of the duct, a ratio (H1/W1) of a height (H1) of the wall to a width (W1) of the inlet of the vehicle interior flow path in a height direction is 0.02 or more and 0.7 or less.
<9> This invention may relate to a vehicle air conditioning system according to any one of <1> to <8>, wherein, when an inlet of the vehicle interior flow path is provided at a position higher than the inner bottom surface of the duct, a ratio (H3/H2) of a height (H3) from the inner bottom surface of the duct to a lower end of the inlet of the vehicle interior flow path to a height (H2) from the inner bottom surface of the duct to an upper end of the inlet of the vehicle interior flow path is 0.02 or more and 0.7 or less.
<10> This invention may relate to a vehicle air conditioning system according to any one of <1> to <9>, wherein, when the duct is provided with at least one drain hole, the total cross-sectional area of the drain hole is 7 mm² or more and 3000 mm² or less.

According to an embodiment of the vehicle air conditioning system of this invention, the system is formed by satisfying at least one of (1) and (2) above, so that it can reduce the risk of condensed water being carried into the vehicle interior to increase the humidity in the vehicle interior.

### BRIEF DESCRIPTION OF THE DRAWINGS

FIG. 1 is a schematic view of a first embodiment of a vehicle air conditioning system according to an embodiment of the invention;

FIG. 2 is a schematic view illustrating a second embodiment of a vehicle air conditioning system in FIG. 1;

FIG. 3 is a schematic view illustrating a third embodiment of a vehicle air conditioning system in FIG. 1;

FIG. 4 is a front view of a wall 4 in FIG. 3;

FIG. 5 is a schematic view illustrating a fourth embodiment of vehicle air conditioning system in FIG. 1;

FIG. 6 is a schematic view illustrating a fifth embodiment of a vehicle air conditioning system in FIG. 1;

FIG. 7 is a schematic view illustrating a sixth embodiment of a vehicle air conditioning system in FIG. 1;

FIG. 8 is a schematic view illustrating a seventh embodiment of a vehicle air conditioning system in FIG. 1;

FIG. 9 is a front view of a first embodiment of a humidity controlling device in FIG. 1;

FIG. 10 is a right side view of a humidity controlling device in FIG. 9;

FIG. 11 is an enlarged view illustrating a region XI in FIG. 9;

FIG. 12 is a perspective view of a second embodiment of a humidity controlling device in FIG. 1; and

FIG. 13 is a perspective view of a third embodiment of a humidity controlling device in FIG. 1.

### DETAILED DESCRIPTION OF THE INVENTION

Hereinafter, embodiments of the invention will be specifically described with reference to the drawings. The invention is not limited to each embodiment, and components can be modified and embodied without departing from the spirit of the invention. Further, various inventions can be formed by appropriately combining a plurality of components disclosed in each embodiment. For example, some components may be removed from all of the components shown in the embodiments. Furthermore, the components of different embodiments may be optionally combined.

### (1. Vehicle Air Conditioning System)

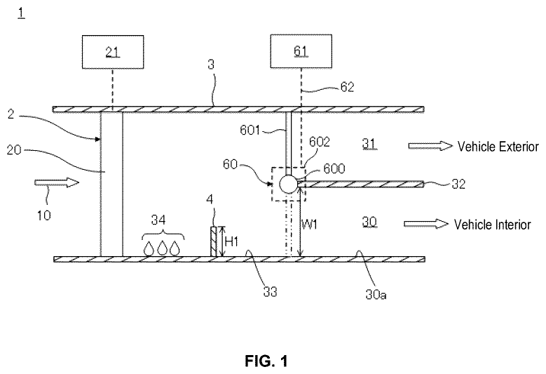

FIG. 1 is a schematic view of a first embodiment of a vehicle air conditioning system 1 according to an embodiment of the invention. The vehicle air conditioning system 1 according to an embodiment is an air conditioning system mounted on various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. In particular, the vehicle air conditioning system 1 according to an embodiment can be suitably used for a vehicle that has no internal combustion engine such as electric vehicles and electric rail cars.

As illustrated in FIG. 1, the vehicle air conditioning system 1 according to an embodiment of the invention includes a humidity controlling device 2 and a duct 3.

The humidity controlling device 2 has an adsorption portion 20 and a heating means 21. The adsorption portion 20 contains an adsorbent capable of adsorbing moisture at a temperature lower than or equal to a predetermined temperature and desorbing the moisture when the temperature exceeds the predetermined temperature. The heating means 21 is configured to heat the adsorption portion 20. Heating of the adsorption portion 20 by the heating means 21 desorbs the moisture from the adsorbent in the adsorption portion 20.

The duct 3 has the humidity controlling device 2 provided therein and can allow an air 10 from the vehicle interior or the vehicle exterior to flow therethrough. The duct 3 has a vehicle interior flow path 30 through which the air 10 that has passed through the humidity controlling device 2 flows into the vehicle interior, and a vehicle exterior flow path 31 through which the air 10 that has passed through the humidity controlling device 2 is discharged to the vehicle exterior. The vehicle interior flow path 30 and the vehicle exterior flow path 31 are separated from each other by a duct partition wall 32. Although not shown, the vehicle interior flow path 30 and the vehicle exterior flow path 31 may be provided at a distance from each other.

In the vehicle air conditioning system 1 according to this embodiment, a wall 4 is erected from an interior bottom 33 of the duct 3 between the humidity controlling device 2 and the vehicle interior flow path 30.

As described above, heating of the adsorption portion 20 by the heating means 21 desorbs the moisture from the adsorbent in the adsorption portion 20. The desorbed moisture causes condensed water 34 to be generated in the duct 3, and depending on the arrangement of the vehicle interior flow path 30, the condensed water 34 may be carried into the vehicle interior to increase the humidity in the vehicle interior. In particular, as illustrated in FIG. 1, when the vehicle interior flow path 30 is located below the vehicle exterior flow path 31 and the inner bottom surface 33 of the duct 3 forms a lower surface 30a of the vehicle interior flow path 30, the condensed water 34 is likely to be carried into the vehicle interior. When the wall 4 is erected from the inner bottom surface 33 of the duct 3 between the humidity controlling device 2 and the vehicle interior flow path 30 as described above, the wall 4 prevents the condensed water 34 from moving into the vehicle interior. This can reduce the risk of the condensed water 34 being carried into the vehicle interior to increase the humidity in the vehicle interior.

The wall 4 may be provided integrally with the duct 3 or may be a separate member from the duct 3. For example, the wall 4 can be provided integrally with the duct 3 by a method of forming the wall 4 by deforming a material that makes up the duct 3, such as a resin. When the wall 4 is formed of the separate member from the duct 3, the wall 4 may be fixed to the inner bottom surface 33 of the duct 3 by any method such as welding.

As Illustrated in FIG. 1, the wall 4 is erected from the inner bottom surface 33 of the duct 3, and when a lower end of an inlet of the vehicle interior flow path 30 is located at a position of the inner bottom surface 33 of the duct 3, a ratio (H1/W1) of a height (H1) of the wall 4 to a width (W1) of the inlet of the vehicle interior flow path 30 in a height direction is preferably 0.02 or more and 0.7 or less. The ratio (H1/W1) of 0.02 or more will more reliably prevent the condensed water 34 being carried into the vehicle interior. The ratio (H1/W1) of 0.7 or less will more reliably suppresses an increase in pressure loss when sending the air 10. The ratio (H1/W1) is more preferably 0.04 or more and 0.6 or less.

The vehicle air conditioning system 1 can have a switching valve 60 that can switch the flow of the air 10 flowing through the duct 3 between the vehicle interior flow path 30 and the vehicle interior flow path 30. The switching valve 60 can cause the air 10 to flow into the vehicle interior flow path 30 when the moisture in the air 10 is adsorbed to the humidity controlling device 2, and can cause the air 10 to flow into the vehicle exterior flow path 31 when the moisture is desorbed from the moisture controlling device 2. FIG. 1 shows the air 10 being allowed to flow into the vehicle interior flow path 30.

The switching of the switching valve 60 can be performed, for example, by electrically connecting the control unit 61 to the switching valve 60 by the electric wire 62 or wirelessly, and operating a switch (not shown) of the switching valve 60 by the control unit 61. The switching valve 60 is not particularly limited as long as it is a valve that is electrically driven and has the function of switching the flow path, and includes electromagnetic valves and electric valves. In an embodiment, the switching valve 60 includes an opening/closing door 601 supported by a rotating shaft 600 and an actuator 602 such as a motor that rotates the rotating shaft 600. The actuator 602 is configured to be controllable by the control unit 61.

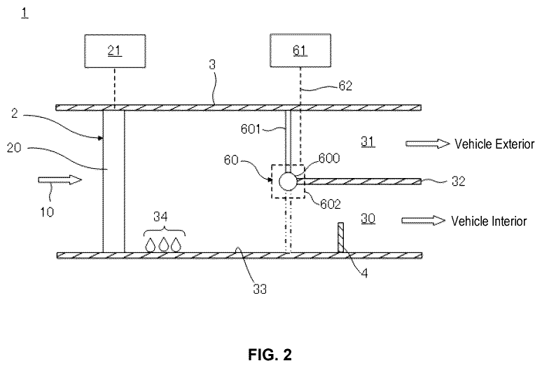

Next, FIG. 2 is a schematic view illustrating a second embodiment of the vehicle air conditioning system 1 in FIG. 1. As illustrated in FIG. 2, the wall 4 may be erected from the inner bottom surface 33 of the duct 3 in the vehicle interior flow path 30. Other configurations are the same as those of the first embodiment.

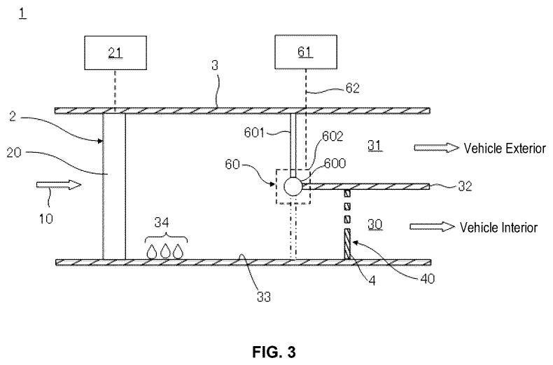

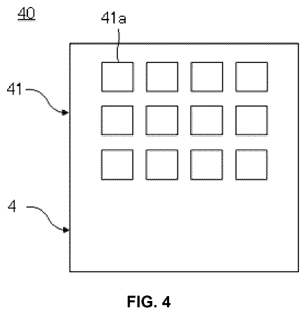

Next, FIG. 3 is a schematic view illustrating a third embodiment of the vehicle air conditioning system 1 in FIG. 1, and FIG. 4 is a front view of the wall 4 in FIG. 3. As illustrated in FIG. 3, the wall 4 may be a part of a member 40 that is fitted into the vehicle interior flow path 30. As illustrated in FIG. 4, the wall 4 is provided at a lower portion of the member 40. An upper portion of the member 40 may be provided with an allowance portion 41 that has at least one opening 41a and allows the air 10 to flow therethrough. The outer shape of the member 40 may be shaped to fit into the inner shape of the vehicle interior flow path 30. Although FIG. 4 shows that the member 40 has a rectangular outer shape, the member 40 may have a circular outer shape. Such a member may be provided between the humidity controlling device 2 and the vehicle interior flow path 30. Other configurations are the same as those of the first and second embodiments.

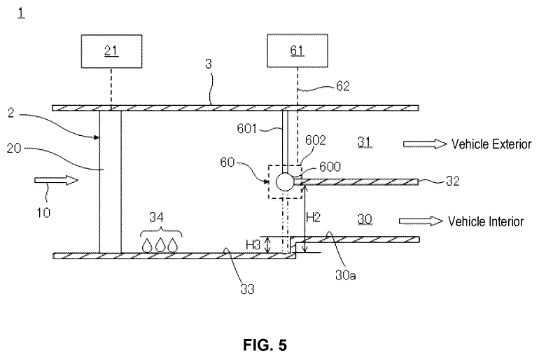

Next, FIG. 5 is a schematic view illustrating a fourth embodiment of the vehicle air conditioning system 1 in FIG. 1. As illustrated in FIG. 5, the inlet of the vehicle interior flow path 30 may be provided at a position higher than the inner bottom surface 33 of the duct 3. In other words, the lower surface 30a of the vehicle interior flow path 30 may be located at a position higher than the inner bottom surface 33 of the duct 3. By thus providing the inlet of the vehicle interior flow path 30, the condensed water 34 can also be prevented from moving into the vehicle interior, thereby reducing the risk of the condensed water 34 being carried into the vehicle interior to increase the humidity in the vehicle interior.

As illustrated in FIG. 5, when the inlet of the vehicle interior flow path 30 is provided at a position higher than the inner bottom surface 33 of the duct 3, a ratio (H3/H2) of a height (H3) from the inner bottom surface 33 of the duct 3 to a lower end of the inlet of the vehicle interior flow path 30 to a height (H2) from the inner bottom surface 33 of the duct 3 to an upper end of the inlet of the vehicle interior flow path 30 is preferably 0.02 or more and 0.7 or less. The ratio (H3/H2) of 0.02 or more will more reliably prevent the condensed water 34 being carried into the vehicle interior. The ratio (H3/H2) of 0.7 or less will more reliably suppresses an increase in pressure loss when sending the air 10. The ratio (H3/H2) is more preferably 0.04 or more and 0.6 or less.

In the fourth embodiment illustrated in FIG. 5, the wall 4 of the first to third embodiments is omitted. However, even when the inlet of the vehicle interior flow path 30 is provided at a position higher than the inner bottom surface 33 of the duct 3 as in the fourth embodiment, the wall 4 of the first to third embodiments may be provided. Other configurations are the same as those of the first to third embodiments.

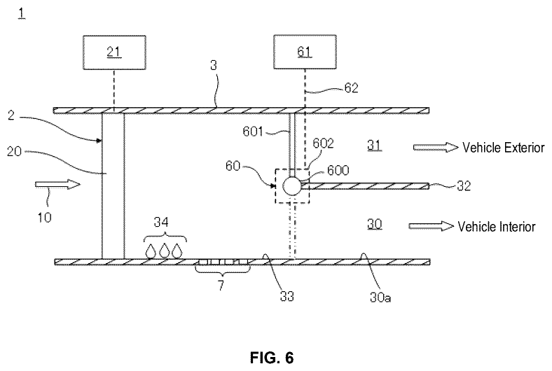

Next, FIG. 6 is a schematic view illustrating a fifth embodiment of the vehicle air conditioning system 1 in FIG. 1. As illustrated in FIG. 6, at least one drain hole 7 may be provided in the inner bottom surface 33 of the duct 3 between the humidity controlling device 2 and the vehicle interior flow path 30. By thus providing the drain hole 7, the condensed water 34 can also be prevented from moving into the vehicle interior, thereby reducing the risk of the condensed water 34 being carried into the vehicle interior to increase the humidity in the vehicle interior. The number and shape of the drain holes 7 may be changed as desired.

When the duct 3 is provided with at least one drain hole 7, the total cross-sectional area of the drain hole is preferably 7 mm² or more and 3000 mm² or less. The total cross-sectional area of the drain holes 7 of 7 mm² or more allows the condensed water 34 to be discharged more reliably. The total cross-sectional area of the drain hole 7 of less than 3000 mm² can suppress a decrease in strength of the duct 3.

In the fifth embodiment illustrated in FIG. 6, the wall 4 of the first to third embodiments is omitted. However, when the drain hole 7 is provided as in the fifth embodiment, the wall 4 of the first to third embodiments may be provided. Also, when the drain hole 7 is provided as in the fifth embodiment, the inlet of the vehicle interior flow path 30 may be provided at a position higher than the inner bottom surface 33 of the duct 3 as in the fourth embodiment. Other configurations are the same as those of the first to fourth embodiments.

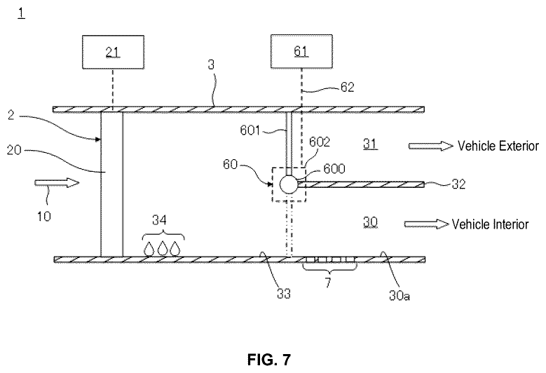

Next, FIG. 7 is a schematic view illustrating a sixth embodiment of the vehicle air conditioning system 1 in FIG. 1. As illustrated in FIG. 7, at least one drain hole 7 may be provided on the inner bottom surface 33 of the duct 3 in the vehicle interior flow path 30. Other configurations are the same as those of the first to fifth embodiments.

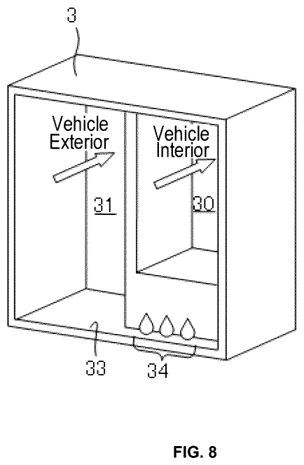

Next, FIG. 8 is a schematic view illustrating a seventh embodiment of the vehicle air conditioning system 1 in FIG. 1. In the descriptions of FIGS. 1 to 7, the vehicle interior flow path 30 is provided below the vehicle exterior flow path 31. However, as in the seventh embodiment illustrated in FIG. 8, the vehicle interior flow path 30 may be provided to the side of the vehicle exterior flow path 31. In the seventh embodiment illustrated in FIG. 8, the inlet of the vehicle interior flow path 30 may be provided at a position higher than the inner bottom surface 33 of the duct 3 as in the fourth embodiment. However, even when the vehicle interior flow path 30 is provided to the side of the vehicle exterior flow path 31, the wall 4 of the first to third embodiments may be provided, or the drain hole 7 may be provided as in the fifth and sixth embodiments. Other configurations are the same as those of the first to sixth embodiments.

### (2. Regarding Humidity Controlling Device)

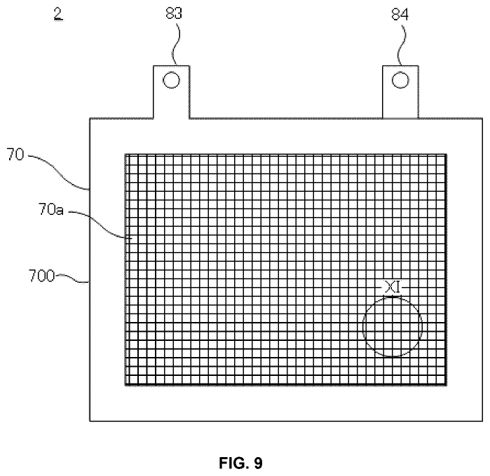

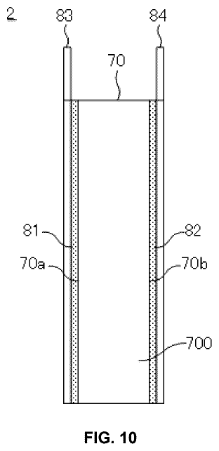

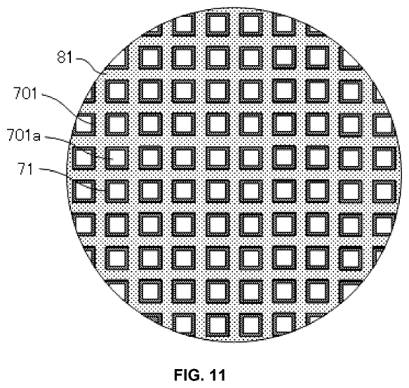

Next, FIG. 9 is a front view illustrating a first embodiment of the humidity controlling device 2 in FIG. 1, FIG. 10 is a right side view illustrating the humidity controlling device 2 in FIG. 9, and FIG. 11 is an enlarged view illustrating the region XI in FIG. 9.

As illustrated in FIGS. 9 to 11, the adsorption portion 20 of the humidity controlling device 2 according to this embodiment has a structure 70 and an adsorbing layer 71. The structure 70 includes: an outer wall 700; and partition walls 701 provided on an inner side of the outer wall 700, the partition walls 701 defining flow paths 701a for the air 10 each extending from a first end face 70a to a second end face 70b. The adsorbing layer 71 is a layer containing the adsorbent as described above, and is provided on each surface of the partition walls 701 as illustrated in FIG. 11. As the air 10 passes through the flow path 701a between the first end face 70a and the second end face 70, the moisture in the air 10 is adsorbed by the adsorbent in the adsorbing layer 71. The flow paths 701a may also be referred to as cells.

In the humidity controlling device 2 according to the first embodiment, the heating means 21 has a pair of electrodes 81, 82 connected to the structure 70, and heats the structure 70 by applying an electric current to the structure 70 through the pair of electrodes 81, 82. Hereinafter, when the electrodes 81, 82 are to be distinguished from each other, one will be referred to as a first electrode 81 and the other as a second electrode 82.

As particularly illustrated in FIG. 10, the first electrode 81 is provided on the first end face 70a of the structure 70, and the second electrode 82 is provided on the second end face 70b of the structure 70. The first electrode 81 and the second electrode 82 are provided on the end face of the outer wall 700, and also provided on the end face of the partition walls 701 as illustrated in FIG. 11. On the first electrode 81 and on the second electrode 82, the flow paths 701a are not plugged. However, a part of flow paths 701a may be plugged on the first electrode 81 and/or by the second electrode 82.

As shown in FIGS. 9 and 10, a first metal terminal 83 may be provided on the first electrode 81, and a second metal terminal 84 may be provided on the second electrode 82. The first metal terminal 83 and the second metal terminal 84 are formed as rectangular frames attached to the outer peripheral portions of the first end face 70a and the second end face 70b, respectively. The first metal terminal 83 and the second metal terminal 84 are provided with extending portions each extending from the rectangular frame outward in the width direction of the structure 70.

A positive electrode of a power source (not shown) is connected to one extending portion of the first metal terminal 83 and the second metal terminal 84, and a negative electrode of the power source is connected to the other extending portion of the first metal terminal 83 and the second metal terminal 84. Assuming that the positive electrode is connected to the extending portion of the first metal terminal 83 and the negative electrode is connected to the extending portion of the second metal terminal 84, the current from the first metal terminal 83 spreads over the first end face 70a through the first electrode 81, flows through the structure 70 in the extending direction of the flow paths 701a, and flows on the second end face 70b through the second electrode 84 into the second metal terminal 84. The current flows in such a manner, thereby heating the structure 70 uniformly.

The structure 70 may be a honeycomb structure in which at least the partition walls 701 are made of a material having a PTC (Positive Temperature Coefficient) property. Further, the material having the PTC property has characteristics such that when the temperature increases to exceed the Curie point, the resistance value is sharply increased, making it difficult for electricity to flow.

Hereinafter, each of the components of the first embodiment of the humidity controlling device 2 will be described in detail.

### (2-1. Regarding Structure)

The shape of the structure 70 (honeycomb structure) is not particularly limited. For example, an outer shape of a cross section of the structure 70 orthogonal to the flow path direction (extending direction of the flow paths 701a) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 70a and second end face 70b) have the same shape as the cross section. Also, when the cross section and the end faces are polygonal, the corners may be chamfered.

The shape of each flow path 701a is not particularly limited, but it may be polygonal such as quadrangular, pentagonal, hexagonal, heptagonal, and octagonal, circular, or oval in the cross section of the structure 70 orthogonal to the flow path direction. These shapes may be alone or in combination of two or more. Moreover, among these shapes, the quadrangle or the hexagon is preferable. By providing the flow paths 701a having such a shape, it is possible to reduce the pressure loss when the air 10 flows. In FIGS. 9 to 11, the structure 70 is illustrated as an example in which the outer shape of the cross section and the shape of each flow path 701a are quadrangular in the cross section orthogonal to the flow path direction of the structure 70.

The structure 70 may be a honeycomb joined body that includes a plurality of honeycomb segments and joining layers that join outer peripheral side surfaces of the plurality of honeycomb segments together. The use of the honeycomb joined body can increase the total cross-sectional area of the flow paths 701a, which is important for ensuring the flow rate of the air 10, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer wall 700 and the partition walls 701. In addition to the role of joining the honeycomb segments to each other, the joining material can also be used as an outer peripheral coating material after joining the honeycomb segments.

From the viewpoints of ensuring the strength of the structure 70, reducing pressure loss when the air 10 passes through the flow paths 701a, ensuring the amount of functional material supported, and ensuring the contact area with the air 10 flowing inside the flow paths 701a, it is desirable to suitably combine a thickness of the partition wall 701, a cell density, and a cell pitch (or an opening ratio of the cells).

As used herein, the cell density refers to a value obtained by dividing a number of cells by an area of one end face (first end face 70a or second end face 70b) of the structure 70 (the total area of the partition walls 701 and the flow paths 701a excluding the outer wall 700).

As used herein, the cell pitch refers to a value obtained by the following calculation. First, the area of one end face (first end face 70a or second end face 70b) of the structure 70 (the total area of the partition walls 701 and the flow paths 701a excluding the outer wall 700) is divided by the number of the cells to calculate an area per a cell. A square root of the area per a cell is then calculated, and this is determined to be the cell pitch.

As used herein, the opening ratio of the cells refers a value obtained by dividing the total area of the flow paths 701a defined by the partition walls 701 by the area of one end face (first end face 70a or second end face 70b) (the total area of the partition walls 701 and the flow paths 701a excluding the outer wall 700) in the cross section orthogonal to the flow path direction of the structure 70. In addition, when calculating the opening ratio of the flow paths 701a, the first electrode 81, the second electrode 82, and an adsorbing layer 71 as described below are not taken into consideration.

In an embodiment that is advantageous from the viewpoint of supporting a sufficient amount of functional material, the thickness of the partition walls 701 is 0.300 mm or less, the cell density is 100 cells/cm² or less, and the cell pitch is 1.0 mm or more. In a preferred embodiment, the thickness of the partition walls 701 is 0.200 mm or less, the cell density is 70 cells/cm² or less, and the cell pitch is 1.2 mm or more. In a more preferred embodiment, the thickness of the partition walls 701 is 0.130 mm or less, the cell density is 65 cells/cm² or less, and the cell pitch is 1.3 mm or more.

In each embodiment as described above, from the viewpoints of ensuring the strength of the structure 70 and maintaining lower electrical resistance, the lower limit of the thickness of the partition walls 701 is preferably 0.010 mm or more, more preferably 0.020 mm or more, and even more preferably 0.030 mm or more.

In each embodiment as described above, from the viewpoints of ensuring the strength of the structure 70, maintaining lower electrical resistance, and increasing a surface area to facilitate reaction, adsorption, and separation, the lower limit of the cell density is preferably 30 cells/cm² or more, more preferably 35 cells/cm² or more, and even more preferably 40 cells/cm² or more.

In each embodiment as described above, from the viewpoints of ensuring the strength of the structure 70, maintaining lower electrical resistance and increasing a surface area to facilitate reaction, adsorption and release, the upper limit of the cell pitch is preferably 2.0 mm or less, more preferably 1.8 mm or less, and even more preferably 1.6 mm or less.

In an embodiment that is advantageous in terms of both reducing pressure loss and maintaining strength, the thickness of the partition walls 701 is 0.08 to 0.36 mm, the cell density is 2.54 to 140 cells/cm², and the opening ratio of the flow paths 701a is 0.70 or more. In a preferred embodiment, the thickness of the partition walls 701 is 0.09 to 0.35 mm, the cell density is 15 to 100 cells/cm², and the opening ratio of the flow paths 701a is 0.80 or more. In a more preferred embodiment, the thickness of the partition walls 701 is 0.14 to 0.30 mm, the cell density is 20 to 90 cells/cm², and the opening ratio of the flow paths 701a is 0.85 or more.

In each embodiment as described above, from the viewpoint of ensuring the strength of the structure 70, the upper limit of the opening ratio of the flow paths 701a is preferably 0.94 or less, more preferably 0.92 or less, and even more preferably 0.90 or less.

Although the thickness of the outer wall 700 is not particularly limited, it is preferably determined based on the following considerations. First, from the viewpoint of reinforcing the structure 70, the thickness of the outer wall 700 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer wall 700 is preferably 1.0 mm or less, more preferably 0.5 mm, even more preferably 0.4 mm or less, and still more preferably 0.3 mm or less.

As used herein, the thickness of the outer wall 700 refers to a length from a boundary between the outer wall 700 and the outermost flow path 701a or the partition wall 701 to a side surface of the structure 70 in a normal line direction of the side surface in the cross section orthogonal to the flow path direction.

The length of the structure 70 in the flow path direction and the cross-sectional area orthogonal to the flow path direction may be adjusted according to the required size of the humidity controlling device 2, and are not particularly limited. For example, when used in a compact humidity controlling device 2 while ensuring a predetermined function, the structure 70 can have a length of 2 to 20 mm in the flow path direction and have a cross-sectional area of 10 cm² or more orthogonal to the flow path direction. Although the upper limit of the cross-sectional area orthogonal to the flow path direction of the structure 70 is not particularly limited, it is, for example, 300 cm².

The partition walls 701 forming the structure 70 are made of a material that can be heated by electric conduction, specifically made of a material having the PTC property. Further, the outer wall 700 may also be made of a material having a PTC property, as with the partition walls 701, as needed. By such a configuration, the adsorbing layer 71 can be directly heated by heat transfer from the heat-generating partition walls 701 (and optionally the outer wall 700). Further, the material having the PTC property has characteristics such that when the temperature increases to exceed the Curie point, the resistance value is sharply increased, making it difficult for electricity to flow. Therefore, when the temperature of the humidity controlling device 2 becomes high, the partition walls 701 (and the outer wall 700 if necessary) have limited current flowing through them, thereby suppressing excessive heat generation of the humidity controlling device 2. Therefore, it is possible to suppress thermal deterioration of the adsorbing layer 71 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271: 2008.

From the viewpoints of creating a device that can be heated by electric conduction and have the PTC property, the outer wall 700 and the partition walls 701 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component. However, it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

The content of the BaTiO₃-based crystalline particles can be measured by fluorescent X-ray analysis. Other crystalline particles can be measured in the same manner as this method.

In terms of reduction of the environmental load, it is desirable that the materials used for the outer wall 700 and the partition walls 701 are substantially free of lead (Pb). Specifically, the outer wall 700 and the partition walls 701 preferably have a Pb content of 0.01% by mass or less, and more preferably 0.001% by mass or less, and still more preferably 0% by mass. The lower Pb content can allow the air 10 heated by contact with the heat-generating partition walls 701 to be safely applied to organisms such as humans, for example. In the outer wall 700 and the partition walls 701, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

In terms of efficiently heating the air, the material making up the outer wall 700 and the partition walls 701 preferably have a lower limit of a Curie point of 80° C. or more, more preferably 80° C. or more, and even more preferably 100° C. or more. Further, in terms of safety as a component placed in the vehicle interior or near the vehicle interior, the upper limit of the Curie point is preferably 250° C. or more, more preferably 225° C. or more, even more preferably 200° C. or more, and still more preferably 150° C. or more.

The Curie point of the material making up the outer wall 700 and the partition walls 701 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC), and a change in electrical resistance of the sample as a function of a temperature change when the temperature is increased from 10° C. is measured using a DC resistance meter (e.g., Multimeter 3478A, from YOKOGAWA HEWLETT PACKARD, LTD.). Based on an electrical resistance-temperature plot obtained by the measurement, a temperature at which the resistance value is twice the resistance value at room temperature (20° C.) is defined as the Curie point.

### (2-2. First Electrode and Second Electrode)

The first electrode 81 and the second electrode 82 are provided on the first end face 70a and the second end face 70b, respectively. Applying a voltage between the first electrode 81 and the second electrode 82 allows the structure 70 to generate heat by Joule heat.

The first electrode 81 and the second electrode 82 may employ, for example, a metal or alloy containing at least one selected from Cu, Ag, Al, Ni and Si, although not particularly limited thereto. It is also possible to use an ohmic electrode capable of ohmic contact with the outer wall 700 and/or the partition walls 701 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the first electrode 81 and the second electrode 82 may have a single-layer structure, or may have a laminated structure of two or more layers. When the first electrode 81 and the second electrode 82 have the laminated structure of two or more layers, the materials of the respective layers may be of the same type or of different types.

The thicknesses of the first electrode 81 and the second electrode 82 may be appropriately set according to the method for forming the first electrode 81 and the second electrode 82. The method for forming the first electrode 81 and the second electrode 82 includes metal deposition methods such as sputtering, vapor deposition, electrolytic deposition, and chemical deposition. Alternatively, the first electrode 81 and the second electrode 82 can be formed by applying an electrode paste and then baking it, or by thermal spraying. Furthermore, the first electrode 81 and the second electrode 82 may be formed by joining metal sheets or alloy sheets.

Each thickness of the first electrode 81 and the second electrode 82 is, for example, about 5 to 30 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-3. First Metal Terminal and Second Metal Terminal)

The provision of the first metal terminal 83 and the second metal terminal 84 facilitates connection to an external power source. The first metal terminal 83 and the second metal terminal 84 are connected to a conductor connected to the external power source.

The metal that makes up the first metal terminal 83 and the second metal terminal 84 may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze. Furthermore, the thickness of each of the first metal terminal 83 and the second metal terminal 84 is not particularly limited, but it is, for example, 0.01 to 10 mm, typically 0.05 to 5 mm.

The method of connecting the first metal terminal 83 and the second metal terminal 84 to the first electrode 81 and the second electrode 82, respectively, is not particularly limited as long as they are electrically connected. For example, they can be connected by diffusion bonding, a mechanical pressing mechanism, welding, or the like.

### (2-4. Intermediate Material)

Intermediate materials may be provided between: the first electrode 81 and the second electrode 82; and the first metal terminal 83 and the second metal terminal 84. The provision of the intermediate materials results in high structural freedom of the connection between the first electrode 81 and the second electrode 82 and the first metal terminal 83 and the second metal terminal 84. The intermediate material may be made of non-limiting materials, and it may be the same as the material of the first metal terminal 83 and the second metal terminal 84 as described above. Moreover, the material of the intermediate material may be different from that of the first metal terminal 83 and the second metal terminal 84 as described above. In this case, the intermediate material can be made of a solder, a brazing material, a conductive adhesive, or the like. The method of connecting the intermediate materials to the first metal terminal 83 and the second metal terminal 84 and the first electrode 81 and the second electrode 82 is not particularly limited as long as they are electrically connected. For example, they can be connected by diffusion bonding, a mechanical pressing mechanism, welding, or the like.

### (2-5. Adsorbing Layer)

As illustrated in FIG. 11, the humidity controlling device 2 may be provided with an adsorbing layer 71 on each surface of the partition walls 701. The adsorbing layer 71 can be provided on the surfaces of the partition walls 701 (in the case of the outermost flow path 701a, the partition walls 701 that define the outermost flow path 701a and the outer wall 700). By thus providing the adsorbing layer 71, the functional material contained in the adsorbing layer 71 can be easily heated, so that the desired function due to the functional material can be exerted.

The adsorbent contained in the adsorbing layer 71 is not particularly limited as long as it can exhibit the desired function. The adsorbent has a function of adsorbing water vapor in the air. The adsorbent preferably has a function of further adsorbing other removing components, for example, at least one selected from carbon dioxide and volatile components. The adsorbing layer 71 may further contain a catalyst. This can allow the removing components to be purified. By using the adsorbent in combination with the catalyst, the function of the adsorbent to capture the removing components can be improved.

The adsorbent preferably has a function that can adsorb the removing components, for example, water vapor, carbon dioxide and volatile components, etc., at −20 to 40° C. and release them at an elevated temperature of 60° C. or more. Examples of the adsorbent having such a function include zeolite, silica gel, activated carbon, alumina, silica, low-crystalline clay, amorphous aluminum silicate complexes, and the like. The type of the adsorbent may be appropriately selected depending on the types of the components to be removed. The adsorbent may be used alone, or in combination with two or more types.

The catalyst preferably has a function capable of promoting the oxidation-reduction reaction. The catalyst having such a function includes metal catalysts such as Pt, Pd and Ag, and oxide catalysts such as CeO₂ and ZrO₂. The catalyst may be used alone or in combination of two or more types.

The volatile components contained in the air in the vehicle interior are, for example, volatile organic compounds (VOCs) and odor components other than the VOCs. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The thickness of the adsorbing layer 71 may be determined according to the size of the flow path 701a, and is not particularly limited. For example, from the viewpoint of ensuring sufficient contact with the air 10, the thickness of the adsorbing layer 71 is preferably 20 μm or more, more preferably 25 μm or more, and even more preferably 30 μm or more. On the other hand, from the viewpoint of suppressing separation of the adsorbing layer 71 from the partition walls 701 and the outer wall 700, the thickness of the adsorbing layer 71 is preferably 400 μm or less, more preferably 380 μm or less, and even more preferably 350 μm or less.

The thickness of the adsorbing layer 71 is measured using the following procedure. Any cross section of the structure 70 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the structure 70. The thickness of each adsorbing layer 71 visually recognized from the cross-sectional image is calculated by dividing the cross-sectional area by the length of the flow paths 701a in the flow path direction. This calculation is performed for all the adsorbing layers 71 visually recognized from the cross-sectional image, and an average value thereof is determined to be the thickness of the adsorbing layer 71.

From the viewpoint that the functional material exerts a desired function in the humidity controlling device 2, an amount of the adsorbing layer 71 is preferably 50 to 500 g/L, more preferably 100 to 400 g/L, and even more preferably 150 to 350 g/L, based on the volume of the structure 70. It should be noted that the volume of the structure 70 is a value determined by the external dimensions of the structure 70.

### (3. Method for Producing Humidity Controlling Device)

The method for producing the humidity controlling device according to an embodiment of the invention is not particularly limited as long as it is a method having the characteristics as described above, and can be carried out in accordance with a known method. Hereinafter, the method for producing the humidity controlling device according to an embodiment of the invention will be specifically described.

A method for producing the honeycomb structure forming the humidity controlling device includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the structure 70 containing, as a main component, BaTiO₃-based crystal particles in which a part of Ba is substituted with the rare earth element.

Further, maintaining the temperature of the honeycomb formed body of 1150 to 1250° C. can allow the Ba₂TiO₄ crystal particles generated in the firing process to be easily removed, so that the structure 70 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed into the structure 70.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. Maintaining the honeycomb formed body at 900 to 950° C. for 0.5 to 5 hours can lead to sufficient decomposition of BaCO₃, so that a structure 70 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

The first electrode 81 and the second electrode 82 are formed on the structure 70 thus obtained, whereby the humidity controlling device 2 can be produced. The first electrode 81 and the second electrode 82 can also be formed by metal deposition methods such as sputtering, vapor deposition, electrolytic deposition, and chemical deposition. Further, the first electrode 81 and the second electrode 82 can also be formed by applying an electrode paste and then baking it. Furthermore, the first electrode 81 and the second electrode 82 can also be formed by thermal spraying. The first electrode 81 and the second electrode 82 may be composed of a single layer, but may also be composed of a plurality of electrode layers having different compositions. A typical method for forming the first electrode 81 and the second electrode 82 will be described below.

First, an electrode slurry containing an electrode material, an organic binder, and a dispersion medium is prepared, and the first end face 70a or the second end face 70b of the structure 70 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the structure 70 is removed by blowing and wiping. The slurry can be then dried to form the first electrode 81 and the second electrode 82 on the first end face 70a or the second end face 70b of the structure 70. The drying can be performed while heating the humidity controlling device 2 to a temperature of about 120 to 600° C., for example. Although a series of steps of coating, slurry removal, and drying may be performed only once, the steps can be repeated multiple times to provide the first electrode 81 and the second electrode 82 having desired thicknesses.

The first metal terminal 83 and the second metal terminal 84 are then placed at predetermined positions of the first electrode 81 and the second electrode 82, respectively, and the first electrode 81 and the second electrode 82 are connected to the first metal terminal 83 and the second metal terminal 84, respectively. As a method of connecting the first electrode 81 and the second electrode 82 to the terminals, the method described above can be used. Further, when the intermediate materials are provided between: the first electrode 81 and the second electrode 82; and the first metal terminal 83 and the second metal terminal 84, the intermediate material can be placed at a predetermined position of the first electrode 81 and the second electrode 82 and connected to each other, and then the first metal terminal 83 and the second metal terminal 84 can be placed at a predetermined position of the intermediate material and connected to each other. As a method for connecting these, the method as described above can be used.

It should be noted that the first metal terminal 83, the second metal terminal 84 and the intermediate material may be provided after the adsorbing layer 71 described below is formed.

The adsorbing layer 71 is then formed on each surface of the partition walls 701 and the like of the humidity controlling device 2 thus obtained, thereby obtaining a humidity controlling device with functional material-containing layers.

Although the method for forming the adsorbing layer 71 is not particularly limited, it can be formed, for example, by the following steps. The humidity controlling device 2 is immersed in a slurry containing a functional material, an organic binder, and a dispersion medium for a predetermined period of time, and an excess slurry on the end faces and the outer periphery of the structure 70 is removed by blowing and wiping. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 71 on the surfaces of the partition walls 701. The drying can be performed while heating the humidity controlling device 2 to a temperature of about 120 to 600° C., for example. Although a series of steps of immersion, slurry removal, and drying may be performed only once, the steps can be repeated multiple times to provide the adsorbing layer 71 having the desired thickness on the surfaces of the partition walls 701 and the like.

### (4. Regarding Second Embodiment of Humidity Controlling Device)

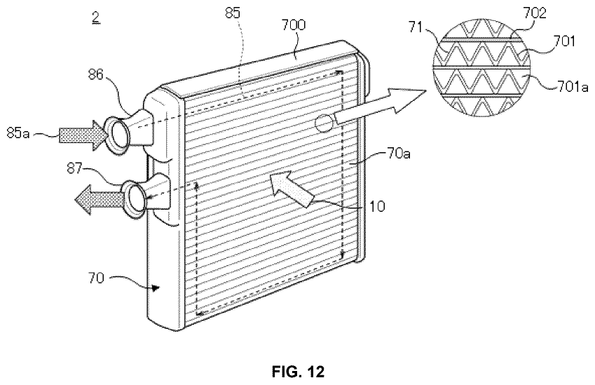

Now, FIG. 12 is a perspective view of a second embodiment of the humidity controlling device 2 in FIG. 1. In the first embodiment of the humidity controlling device 2 illustrated in FIGS. 9 to 11, the honeycomb structure as the structure 70 was heated by electrical conduction. However, the structure 70 may be heated by other methods. In the second embodiment of the humidity controlling device 2 illustrated in FIG. 12, the heating means 21 has a pipe 85 provided inside the structure 70, and the structure 70 is heated by allowing a heated medium 85a to flow through the pipe 85.

The pipe 85 may be passed through the interior of the honeycomb structure described above, but a structure such as a so-called radiator may also be used as the structure 70. In the second embodiment of the humidity controlling device 2 illustrated in FIG. 12, the structure 70 includes: an outer wall 700; a plurality of intermediate walls 702 provided on an inner side of the outer wall 700; and fin bodies as the partition walls 701 each provided between the outer wall 700 and the intermediate wall 702 and between the intermediate walls 702. The fin bodies define flow paths 701a for the air 10 each extending from the first end face 70a to the second end face (the back surface in the figure). The adsorbing layer 71 is provided on each surface of the fin bodies as the partition walls 701.

The outer wall 70 is provided with an introduction port 86 and a discharge port 87, and the pipe 85 extends between the introduction port 86 and the discharge port 87. The medium 85a from the introduction port 86 passes through the pipe 85 and is discharged from the discharge port 87. Although the pipe 85 is depicted in a simplified manner in FIG. 12, the pipe 85 is actually bent and/or branched so as to extend throughout the entire structure 70. Other configurations are the same as the first embodiment of the humidity controlling device 2.

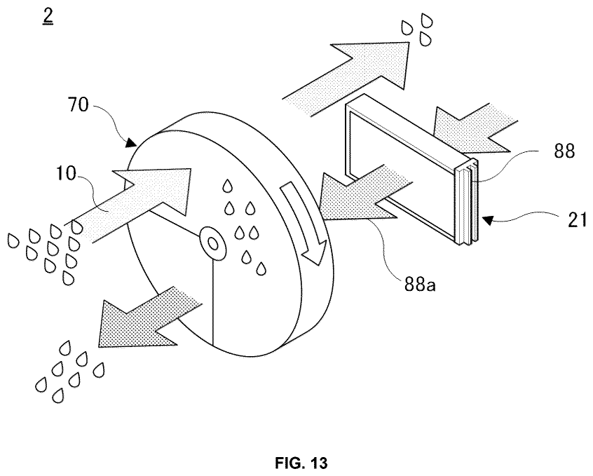

Now, FIG. 13 is a perspective view of a third embodiment of the humidity controlling device 2 in FIG. 1. In the third embodiment of the humidity controlling device 2 illustrated in FIG. 13, the heating means 21 has a heater 88 that feeds a heated air 88a to the structure 70, and heats the structure 70 by passing the heated air 88a through the structure 70.

Such a heating means 21 may be used in combination with the fixed structure 70, but it may also be used in combination with a rotatably provided structure 70 as illustrated in FIG. 13. Specifically, the honeycomb structure as the structure 70 may be provided rotatably around a rotational axis extending along the central axis of the honeycomb structure. At this time, the air 10 into which moisture is adsorbed may be fed to a partial region (e.g., ¼ region) of the end face of the structure 70 (honeycomb structure), and the heated air 88a may be fed to the other region (e.g., other ¼ region) of the end face of the structure 70. A portion of the structure 70 that has absorbed the moisture from the air 10 moves to a position where it receives the feed of the heated air 88a by rotation of the structure 70. This allows the moisture to be adsorbed in one portion of the structure 70 while at the same time desorbing the moisture from the other portion. The heated air 88a may flow in the same direction as the air 10, but in FIG. 13 it flows in the opposite direction to the air 10. This allows the piping layout to be simplified. Other configurations are the same as the first and second embodiments of the humidity controlling device 2.

While the preferred embodiments of the invention have been described above in detail with reference to the drawings, the present invention is not limited to such embodiments. It is obvious that a person skilled in the art to which this invention belongs can arrive at various variations or modifications in the scope of the technical idea recited in the claims, and it is understood that they also belong to the technical scope of this invention.

### EXAMPLES

The invention will be more specifically described by means of the following Examples. The invention is not limited to these examples.

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.
Shape of cross section and end face of honeycomb structure orthogonal to flow path direction: quadrangular;
Dimensions of honeycomb structure: horizontal width of 114 mm, vertical width of 114 mm, length of 10 mm;
Shape of cross section of cells orthogonal to flow path direction: quadrangular;
Thickness of partition walls: 0.127 mm;
Thickness of outer peripheral wall: 0.8 mm;
Cell density: 85.3 cells/cm²;
Cell pitch: 1.08 mm;
Opening Ratio of Cells: 0.55 to 0.80;
Cross-sectional area of honeycomb structure orthogonal to extending direction of flow path: 13000 mm²;
Length of honeycomb structure in extending direction of flow path: 10 mm;
Volume resistivity of materials making up partition walls (and outer peripheral wall) at 25° C.: 12 Ω·cm; and
Curie point of material making up partition walls (and outer peripheral wall): 120° C.

The volume resistivity of the partition walls was controlled by adjusting the mixing ratio of the raw materials and firing conditions.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The first electrode and the second electrode each having a thickness of 0.05 mm were formed on both end faces (first end face and second end face) of the resulting honeycomb structure, respectively. The first electrode and the second electrode were formed as follows: First, an electrode slurry containing aluminum (electrode material), ethyl cellulose and diethylene glycol monobutyl ether (organic binder) was prepared and applied to the first end face. Subsequently, an excess electrode slurry on the outer periphery of the honeycomb structure was removed by blowing and wiping, and the electrode slurry was then dried to form an electrode on one end face. Similarly, an electrode was formed on the other end face.

The honeycomb structure with the first electrode and the second electrode formed was then immersed in a slurry containing zeolite (adsorbent) as a functional material, an organic binder, and water, and the slurry adhering to excess positions (such as the outer periphery) was removed by blowing and wiping, and then dried at about 550° C. to form a functional material-containing layer at the predetermined position.

Subsequently, the first metal terminal was joined onto the first electrode and the second metal terminal was joined onto the second electrode. The first metal terminal and the second metal terminal were joined as follows: Each of the first metal terminal and the second metal terminal used was a strip-shaped metal body made of SUS430 and having a width of 3.5 mm and a thickness of 0.7 mm. The overall outer shape of the first metal terminal and the second metal terminal was a rectangular frame shape. The first metal terminal and the second metal terminal were joined by soldering onto the first electrode and the second electrode, respectively, while aligning the outer edges of the first metal terminal and the second metal terminal with the outer edges of both end faces of the honeycomb structure, respectively.

### Example 1

A sample of the humidity controlling device obtained as described above was placed inside the duct as illustrated in FIG. 1. The dimensions of each portion of the duct are as follows:
Inner dimensions of the duct at a position upstream of the branching position of the vehicle interior flow path and the vehicle exterior flow path: horizontal width 114 mm, vertical width 114 mm, length 200 mm;
Position of the vehicle interior flow path: below the vehicle exterior flow path;
Internal dimensions of the vehicle interior flow path: horizontal width 114 mm, vertical width 50 mm, length 100 mm;
Internal dimensions of the vehicle exterior flow path: horizontal width 114 mm, vertical width 50 mm, length 100 mm;
Distance from the end face on the downstream side of the humidity controlling device to the branching position of the vehicle interior flow path and the vehicle exterior flow path: 170 mm;
Distance from the end face on the downstream side of the humidity controlling device to the end face on the upstream side of the wall: 90 mm; and
Thickness of the wall: 40 mm.

The following evaluation was performed while changing the ratio (H1/W1) of the height (H1) of the wall to the width (the vertical width described above) (W1) of the inlet of the vehicle interior flow path in the height direction, as shown in Table 1 below.

### (Dehumidifying Performance)

The vehicle air conditioning system was subjected to the regeneration mode, followed by the moisture absorption mode. The regeneration mode was performed by starting the ventilation fan and allowing the air at a temperature of 25° C. and at relative humidity of 40% to flow at a flow rate of 0.05 m³/min through the air conditioning duct while applying a voltage of 12 V from a direct current power source to the humidity controlling device for 3 minutes. The moisture absorption mode was performed by allowing the air under the same conditions to flow in the air conditioning duct for 3 minutes at a flow rate of 0.8 m³/min, without applying a voltage to the humidity controlling device. In the moisture absorption mode, the absolute humidity [g/m³] at the inlet (upstream side) and outlet (downstream side) of the humidity controlling device was measured, and an amount of moisture absorbed [g] was calculated by the following equation:

Amount of moisture absorbed [g]=(absolute humidity at inlet of humidity controlling device [g/m³]−absolute humidity at outlet of humidity controlling device [g/m³])×flow rate m³/min]×duration time for adsorption mode [min].

In Table 1 below, samples having an amount of moisture adsorbed of 7 g or more are expressed as “circle”, and samples having an amount of moisture adsorbed of less than 7 g are expressed as “x”. Since the amount of moisture adsorbed of 7 g or more allows sufficient dehumidification, it is acceptable.

### (Pressure Loss)

Pressure loss was measured for a vehicle air conditioning system. The measurement was performed by starting the ventilation fan and allowing the air at a temperature of 25° C. and at relative humidity of 40% to flow at a flow rate of 0.8 m³/min through the air conditioning duct for 3 minutes. The pressure loss [Pa] was calculated based on the following equation:

$$Pressure loss = Py - P z$$

In the equation, Py is a pressure [Pa] at a position on an upstream side of the humidity controlling device and Pz is a pressure [Pa] at a position on a downstream side of the humidity controlling device.

In Table 1 below, samples having a pressure loss of less than 90 Pa were expressed as “circle”, and samples having a pressure loss of 90 Pa or more are expressed as “x”. Since the pressure loss of less than 90 Pa allows for ventilation without increasing a blower output, it is acceptable.

TABLE 1

| Nos. | H1/W1 | Dehumidification Performance | Pressure Loss |
|---|---|---|---|
| 1 | 0.01 | x | ○ |
| 2 | 0.02 | ○ | ○ |
| 3 | 0.7 | ○ | ○ |
| 4 | 0.8 | ○ | x |

As shown in Table 1, in No. 1 in which the ratio (H1/W1) was 0.01, the dehumidification performance was evaluated as “x”. This would be because the height (H1) was lower than the width (W1), and the movement of the condensed water into the vehicle interior was not sufficiently prevented. Further, in No. 4 in which the ratio (H1/W1) was 0.8, the evaluation of the pressure loss was “x”. This would be because the height (H1) was higher than the width (W1), and the wall prevented the flow of the air. On the other hand, in Nos. 2 and 3 in which the ratio (H1/W1) was 0.02 or more and 0.7 or less, the dehumidification performance and pressure loss were evaluated as “circle”. The results confirm that the ratio (H1/W1) is preferably 0.02 or more and 0.7 or less.

### Example 2

A sample of the humidity controlling device obtained as described above was placed inside the duct as illustrated in FIG. 5. The dimensions of each portion of the duct are as follows:
Inner dimensions of the duct at a position upstream of the branching position of the vehicle interior flow path and the vehicle exterior flow path: horizontal width 114 mm, vertical width 114 mm, length 200 mm;
Position of the vehicle interior flow path: below the vehicle exterior flow path;
Internal dimensions of the vehicle interior flow path: horizontal width 114 mm, vertical width according to the proportion in Table 2, length 100 mm;
Internal dimensions of the vehicle exterior flow path: horizontal width 114 mm, vertical width 50 mm, length 100 mm;
Distance from the downstream end face of the humidity controlling device to the branching position of the vehicle interior flow path and the vehicle exterior flow path: 170 mm.

The dehumidification performance and pressure loss were then evaluated by the same procedure as that of Example 1 described above while changing the ratio (H3/H2) of the height (H3) from the inner bottom surface of the duct to the lower end of the inlet of the vehicle interior flow path to the height (vertical width of the vehicle interior flow path) (H2) from the inner bottom surface of the duct to the upper end of the inlet of the vehicle interior flow path as shown in Table 2 below.

TABLE 2

| Nos. | H3/H2 | Dehumidification Performance | Pressure Loss |
|---|---|---|---|
| 5 | 0.01 | x | ○ |
| 6 | 0.02 | ○ | ○ |
| 7 | 0.7 | ○ | ○ |
| 8 | 0.8 | ○ | x |

As shown in Table 2, in No. 5 in which the ratio (H3/H2) was 0.01, the dehumidification performance was evaluated as “x”. This would be because the height (H3) was lower than the height (H2), and the movement of the condensed water into the vehicle interior was not sufficiently prevented. Further, in No. 8 in which the ratio (H3/H2) was 0.8, the evaluation of the pressure loss was “x”. This would be because the height (H3) is higher than the height (H2), and the flow of the air is prevented by a step at the inlet of the vehicle interior flow path. On the other hand, in Nos. 6 and 7 in which the ratio (H3/H2) was 0.02 or more and 0.7 or less, the dehumidification performance and pressure loss were evaluated as “circle”. The results confirm that the ratio (H3/H2) is preferably 0.02 or more and 0.7 or less.

### Example 3

A sample of the humidity controlling device obtained as described above was placed inside the duct as illustrated in FIG. 6. The dimensions of each portion of the duct are as follows:
Inner dimensions of the duct at a position upstream of the branching position of the vehicle interior flow path and the vehicle exterior flow path: horizontal width 114 mm, vertical width 114 mm, length 200 mm;
Position of the vehicle interior flow path: below the vehicle exterior flow path;
Internal dimensions of the vehicle interior flow path: horizontal width 114 mm, vertical width 50 mm, length 100 mm;
Internal dimensions of the vehicle exterior flow path: horizontal width 114 mm, vertical width 50 mm, length 100 mm;
Distance from the end face on the downstream side of the humidity controlling device to the branching position of the vehicle interior flow path and the vehicle exterior flow path: 170 mm;
Shape of drain hole: round;
Dimensions and number of drain holes: according to the total cross-sectional area of the drain hole in Table 3;
Distribution of drain holes: parallel arrangement (the number of rows is according to the total cross-sectional area of the drain holes in Table 3);
Distance from the end face on the downstream side of the humidity controlling device to the end on the upstream side of the drain hole: 60 mm.

The dehumidification performance was then evaluated by the same procedure as that of Examples 1 and 2 described above while changing the total cross-sectional area of the drain holes as shown in Table 3 below. In Example 3, the following evaluation of yield strength was performed instead of the evaluation of pressure loss.

### (Yield Strength)

The yield strength was calculated from the test based on JIS Z 2241. A percent reduction in yield strength due to drilling was calculated based on the following equation:

$$Percent reduction in yeild strength = \{ ( yield strength wihout holes - yield strength with holes ) / yield strength without holes \} \times 100$$

In Table 3 below, samples in which the percent reduction in yield strength was less than 50% are expressed as “circle”, and samples in which the percent reduction in yield strength was 50% or more are evaluated as “x”. If the percent reduction in yield strength is less than 50%, it is acceptable because breakage may not occur during use.

TABLE 3

| | Total Cross- | | |
|---|---|---|---|
| | Sectional Area | Dehumidification | |
| Nos. | [mm²] | Performance | Yield Strength |
| 9 | 5 | x | ○ |
| 10 | 7 | ○ | ○ |
| 11 | 3000 | ○ | ○ |
| 12 | 3500 | ○ | x |

As shown in Table 3, the dehumidification performance of No. 9 in which the total cross-sectional area of the drain holes was 5 mm was evaluated as “x”. This would be because the total cross-sectional area of the drain holes was smaller, and the movement of the condensed water into the vehicle interior was not sufficiently prevented. Further, the yield strength of No. 12, in which the total cross-sectional area of the drain holes was 3500 mm², was evaluated as “x”. This would be because the total cross-sectional area of the drain holes was larger, and the drain holes reduced the strength of the duct. On the other hand, in Nos. 10 and 11 in which the total cross-sectional area of the drain holes was 7 mm² or more and 3000 mm² or less, the dehumidification performance and yield strength were evaluated as “circle”. From these results, it was confirmed that the total cross-sectional area of the drain holes is preferably 7 mm² or more and 3000 mm² or less.

### DESCRIPTION OF REFERENCE NUMERALS

1: vehicle air conditioning system
2: humidity controlling device
3: duct
4: wall
7: drain hole
10: air
20: adsorption portion
21: heating means
30: vehicle interior flow path
31: vehicle exterior flow path
33: inner bottom surface
70: structure
70a: first end face
70b: second end face
71: adsorbing layer
81: electrode
82: electrode
85: pipe
85a: medium
88: heater
88a: heated air
700: outer wall
701: partition wall
701a: flow path

1. A vehicle air conditioning system, comprising:
a humidity controlling device having an adsorption portion containing an adsorbent configured to adsorb moisture at a temperature lower than or equal to a predetermined temperature and to desorb the moisture when the temperature exceeds the predetermined temperature, and a heating means configured to heat the adsorption portion;
a duct comprising the humidity controlling device therein and allowing air from a vehicle interior or a vehicle exterior to flow therethrough, the duct having a vehicle interior flow path for introducing the air that has passed through the humidity controlling device into the vehicle interior, and a vehicle exterior flow path for discharging the air that has passed through the humidity controlling device to the vehicle exterior,
wherein the vehicle air conditioning system is formed by satisfying at least one of (1) and (2) as follows:
(1) a wall is erected from an inner bottom surface of the duct between the humidity controlling device and the vehicle interior flow path or in the vehicle interior flow path, or an inlet of the vehicle interior flow path is provided at a position higher than the inner bottom surface of the duct; and
(2) at least one drain hole is provided at the inner bottom surface of the duct between the humidity controlling device and the vehicle interior flow path or in the vehicle interior flow path.

2. The vehicle air conditioning system according to claim 1, wherein the adsorption portion comprises:
a structure having an outer wall and partition walls provided on an inner side of the outer wall, the partition walls defining flow paths for the air, each of the flow paths extending from a first end face to a second end face of the structure; and
an adsorbing layer containing the adsorbent, the adsorbing layer being provided on a surface of each of the partition walls.

3. The vehicle air conditioning system according to claim 2, wherein the heating means has a pair of electrodes connected to the structure, and the structure is heated by applying an electric current through the pair of electrodes.

4. The vehicle air conditioning system according to claim 3, wherein at least the partition walls of the structure are made of a material having a positive temperature coefficient (PTC) property.

5. The vehicle air conditioning system according to claim 2, wherein the heating means has a pipe provided inside the structure, and the structure is heated by a heated medium flowing through the pipe.

6. The vehicle air conditioning system according to claim 2, wherein the heating means has a heater for feeding heated air to the structure, and the structure is heated by allowing the heated air to flow through the structure.

7. The vehicle air conditioning system according to claim 1, wherein the vehicle interior flow path is provided below or to a side of the vehicle exterior flow path.

8. The vehicle air conditioning system according to claim 1, wherein a wall is erected from an inner bottom surface of the duct, and when a lower end of an inlet of the vehicle interior flow path is located at a position of the inner bottom surface of the duct, a ratio (H1/W1) of a height (H1) of the wall to a width (W1) of the inlet of the vehicle interior flow path in a height direction is 0.02 or more and 0.7 or less.

9. The vehicle air conditioning system according to claim 1, wherein, when an inlet of the vehicle interior flow path is provided at a position higher than the inner bottom surface of the duct, a ratio (H3/H2) of a height (H3) from the inner bottom surface of the duct to a lower end of the inlet of the vehicle interior flow path to a height (H2) from the inner bottom surface of the duct to an upper end of the inlet of the vehicle interior flow path is 0.02 or more and 0.7 or less.

10. The vehicle air conditioning system according to claim 1, wherein, when the duct is provided with at least one drain hole, the total cross-sectional area of the drain hole is 7 mm² or more and 3000 mm² or less.
